(19) United States
(12) Patent Application Publication
(10) Pub. No.: US 2017/0285974 A1
(43) Pub. Date: Oct. 5, 2017

(54) Procedures, Methods and Systems for Computer Data Storage Security

(71) Applicant: James Michael Patock, SR., Fredericksburg, VA (US)

(72) Inventor: James Michael Patock, SR., Fredericksburg, VA (US)

(21) Appl. No.: 15/084,537

(22) Filed: Mar. 30, 2016

(51) Int. Cl. G06F 3/06

(52) U.S. Cl. CPC G06F 3/0619; G06F 3/0688; G06F 3/0655; G06F 3/065

(57) ABSTRACT

This patent covers a new paradigm for securely storing data by placing it in a data storage medium in non-sequential quasi randomly mapped series of data blocks that cannot be located without the aid of the microcomputer or computer controlling system and program. It contains a new method of encoding data by entangling the intermixed data bits of each symbol with a larger number of data bits in a storage field. It also normally utilizes a microprocessor, microcontroller, or computer, which actively controls the entanglement as well as the location of data within a data storage medium, which may have multiple access points for the reading, and writing of data to and from the storage medium.

### BACKGROUND OF PATENT

The patent addresses well-known problems with the lack of privacy and security relating to digital data stored on a wide variety of storage mediums, such as hard drives, flash memories, and semiconductor storage arrays. Currently, someone with sufficient computer power can decode almost any form of encryption available to someone who wishes to keep their data secure.

### PATENT SUMMARY

This patent covers several processes and the computer programs to control those processes. The programs and processes are designed to provide complete security for data stored on any rewritable device that can store digital data such as binary code. Examples of this are hard disk drives, flash memories and flash memory arrays, semiconductor memories and semiconductor memory arrays, rewritable CDs and rewritable DVDs, and any other related device. The preferred method controlling the storage and running the computer programs and processes is that it is done on one or more dedicated microprocessors, microcontrollers, or computer systems attached to and controlling the storage medium and access to the data on the storage medium. One microprocessor or microcontroller controls a single access point or system to the memory system. The dedicated devices just mentioned function as read-only processors so that their programs may not be altered by any external source.

However, in the case of older systems where a microcontroller or microprocessor is not available and it is not feasible to add one as might be the case in existing computer systems, then a controlling program could be stored on a read-only flash memory chip and the controlling program could still provide effective control of the data and entangling the links between data files and data blocks.

The system is primarily empirical and engineering oriented rather than mathematical. Except for the concept of data entanglement, which is a potent coding system in itself, the processes and systems are generally based on the concept that it is better to deny access to the data than attempt to encrypt it in some manner that cannot be decrypted.

History is shown that it is generally impossible to prevent someone with access to modern computers from breaking any encryption system's that has a large population of examples for the computers to work with and decrypt.

Therefore, the only way to keep data secure and private is to store it in some manner that cannot be accessed or copied by an unauthorized entity.

### Spatial Encoding

Spatial Encoding is a system that will prevent unauthorized entities from accessing or copying private data. The programs and processes start with a mapping of the storage device to a geometric or mathematical set of coordinates that emulate a coordinate system, which provides random-access to any digital/binary bit of information stored on the device by using three-dimensional sets of coordinates. Examples of this are Cartesian coordinates, polar coordinates, spherical coordinates, and Plucker coordinates as well as any other related mathematical or geometric set of coordinates. The mapping system is controlled by the controlling computer processor/microcontroller and results in a coding system that stores the data according to the coordinates of the mapping system rather than the coordinates of the storage medium and thereby hides the location of the data from any external observation or copying.

The system also may provide a dummy structure of used data blocks surrounding or appearing to surround actual data for obscuring locations of initial data file storage, which may provide such a small number of data blocks as to be possibly copied if a search function happens to occur upon initial initialization. It should be noted that even if the initial data file were copied, this would not necessarily provide a method of copying subsequent data blocks. The system provides completely random storage for each data file and the pointers used in one system of a data file and data blocks are not the same as that used in subsequent data files/data block storage. The pointers are also encoded using data entanglement, which is impractical if not impossible to decode in any amount of time that would give access to subsequent or previous data block before they are moved and/or recoded in regards to their position. It also would require a significant amount of time to decode a data file even if it were possible. By the time a data block was actually completely decoded, that data block and the remainder of the data blocks in that data file would probably have been moved and provided with new pointers and perhaps even a new file coordinate system.

For example, while patent application Ser. No. 14/043,387 allows for downloading data from the Internet directly to paper copy on a printer, there was no possibility prior to this patent to allow such data to be secure from access. Partially this stems from the fact that the original file access tables and methods of storing data were designed to make them convenient and easy and therefore insecure. To date only the methods outlined in this patent application are an attempt to prevent access to the data rather than securely encrypting the data. It is based on the principle that hidden data is an improvement of many orders of magnitude over encrypted data.

### Data Entanglement

The second process is called data entanglement and starts with taking the message or data block being encoded and entangles it by breaking it up into blocks of either one size or a variety of sizes appropriate with the spatial encoding and mapping system selected by the computer processor/microcontroller. Once the blocks of binary data have been set up, the data is entangled by mixing it with a larger block of binary data. For example, an 8-bit block of binary data can be mixed in with a 16 bit block of random data so that the meaningful data from the eight bit block alternates with random data bits and thereby produces a 16 bit block of data that cannot be deciphered by standard encryption methods. The 8-bit data block could also be placed in a 64-bit data block or any size block of data and encoded in any sequence that can be stored and remembered by the computer processor/microcontroller. Essentially, the meaningful data can be hidden in so many different ways that it would be impossible to break the data out without detailed knowledge of how it was entangled with the random data.

In regards to Shannon's definition of sufficient confusion and sufficient diffusion resulting in a secure algorithm, notice that even if a particular string of binary data is somehow extracted correctly from a particular data file, if the string of data is entangled then there are still at least two major issues that have to be overcome before the data strings associated with a particular character can be subject to standard decoding techniques. First, the entity attempting to break out the data must correctly infer the length of the entangled string. If the entity does not have the correct length for the entangled data string (seven binary digits in a 14/16 bit string or eight binary digits in a 16-bit string) then there is no way that decoding can even begin. Secondly, even if the correct length of string is somehow inferred, then there is still the problem that only one in 64,000 data strings for the first 16 bit entangled data is the correct one for a given character. The entity still has to find the correct string and then decide where the eight data bits (for example) reside within the 16-bit string. At this point there does not seem to be any mathematical method that I am aware of that can do this type of decoding. Therefore, the algorithm appears to be indecipherable, cannot be decoded, and therefore meets Shannon's definition of a perfectly secure system.

### ENTANGLEMENT EXAMPLE

For the purposes of the example, we will set the 6-digit code 111000 as the letter E and the 12-digit code 000000111111 as the entanglement location. We will then say that the 6-digit code will be entangled in the even-numbered bits were three occurrences of a simple rotation sequence.

010101101010 in the first example

010100101011 and the second example

010000101111 for the third example.

All of the above examples decode as the letter ‘E’ but the decoding of the entanglement is only known by the microprocessor/microcontroller system. Note that it is possible for another coded letter to have the same binary sequence after entanglement as one of the above letter ‘E’s but will still decode as a different but correct letter.

In regards to Shannon's definition of a secure algorithm which be achieved by sufficient confusion and sufficient diffusion so that in this secure algorithm, notice that even if a particular string or data block of binary data is somehow extracted correctly from a particular data file, if the string of data is entangled then there are still at least two major issues that have to be overcome before the data strings associated with a particular character can be subject to standard decoding techniques. First, the entity attempting to break out the data must correctly infer the length of the entangled string. If the entity does not have the correct length for the entangled data string (such as seven binary digits in a 14/16 bit string or eight binary digits in a 16-bit string) then there is no way to begin effective decoding.

The hacking entity still has to find a correct string location and then decide where the eight data bits (for example) reside within the 16-bit string. Secondly, even if a correct string location is somehow discovered, then there is still the problem that only one in 64,000 data strings for the first 16 bit entangled data string is the correct one for a given character. At this point there does not seem to be any mathematical method that I am aware of that can do this type of decoding. Therefore, the algorithm appears to be indecipherable and cannot be decoded and therefore meets Shannon's definition of a perfectly secure system.

Taking the above example is a starting point I will now show you an example of what might be considered a real-life encoding of a data file and what a hacker or state entity would have to attempt to do in order to decode a entangled and spatially encoded data file. This example assumes an eight-bit symbol code size and a sixteen-bit storage area size for a number of symbols chosen by the controller/microprocessor system.

The sample file will be broken up into several one thousand twenty-four sixteen-character blocks and then entangled by the microcontroller microprocessor system and then spatially encoding it and then continuously or periodically “churning ”(explained later but is essentially moving or recoding the file system will add further difficulty

The file will also be specified as having a beginning of three words that have a triple repeat of the letters A and E in them (need lead bad) so that it should be easy to deduce them using traditional methods and from there traditional methods would deduce the three words and be well on its way to breaking the code. Obviously, that will not work here. Instead, I will demonstrate the extreme difficulty of deciphering a file encoded and entangled by this method.

This information will take the decoding entity to the location of the first binary bit in the data file. In my opinion, any progress from this point will require some form of brute force decoding of not just a consecutive bits in a line of data but a volume scattered around the disk drive or memory system.

I believe it would take at least three separate brute force attacks or processes to decode the block of data and obtain the pointer to the next block.

The third process involves taking the data blocks that have been entangled and forming them into a sequence of data blocks by placing additional information on the location of the previous and following data block somewhere in the data of each data block to link the data block into its correct location in the sequence. The data blocks are then placed in random locations on the storage medium in such a way that an attempt to sequentially locate the data blocks is impossible. For example, data block one could be placed at location 0, 0, 1 in a Cartesian coordinate system and data block two could be placed at location 17, 32, 54 so that the only way to find the location of the second data block is to find the first data block and break the code linking it to the second data block. The second data block of course links to the third data block and so on with no way of finding a particular data block without decoding the previous or the following data block location information.

One extremely useful product of this system is rapid message transfers. By pre-selecting a location and time for placing data blocks on a secure system as described in this patent or for that matter on any hard disk drive, flash memory or other storage system used as part of the “cloud systems” or “cloud” or anything connected to the Internet. This means the movement of the data from one computer to another via an Internet location where the data is stored for an extremely brief period of time before being copied down to the recipient's computer, external storage location, or directly to a printer.

Since the location and time is known only to be sender and to the recipient, it would be possible for the sender to place the data block or other information at the Internet location at the prescribed moment and immediately afterwards, the recipient would download the data block in an extremely short period of time and either the sender or recipient could then later working on, erase and write over the location or locations where the data was stored so that the data is only on the Internet for periods of time generally described by tens of milliseconds or less which would make it impossible for anyone to intercept the data before it was copied down to either a secure location that may be quickly disconnected from the Internet or to a location as part of a secure printer system as described in my previous patent application (Ser. No. 14/043,387).

The system does not necessarily require computer contact to pass the messages on times and location because it could be done by telephone or other non-computer methods of passing information. The principle in general is the high-speed of transfer, which minimizes the amount of time data remains on the Internet or on a computer connected to the Internet. Large amounts of data could be broken into a number of packet sized blocks of information (or any size that provides efficiency without compromising speed or security—i.e. extremely large messages might compromise security) that could utilize different locations and even different sequences (last block of data sent 1st or random sequence or . . . ) And sent utilizing different routes and different intermediate locations.

Special portions of the main DNS servers or random sets of storage locations could be set up within the Internet to provide transfer locations that are periodically churned/moved to prevent interception. It should be noted that even if a system managed to be set up to intercept the entirety of the data stream going into a location, no system of computers currently available or even possibly available could keep up with the amount of data being streamed and there is no way that they could possibly obtain a particular message or group of messages from the tremendous amount of data being sent into even one DNS server or commercially available server location.

Transfer to a paper copy means that the information would not remain anywhere on any computer after the data was transferred. This presumes that the sender either had the copy on an external memory system or (if on a computer) erases the data from the computer immediately after sending it or transfers it to a flash drive or other external system that is immediately disconnected from the Internet.

The fourth process involves what this patent specification calls ‘churning’ which involves either moving the data from one location to another either in its entirety or effectively changing the sequence by moving one or two blocks of data to a different location. In addition, the mapping system can affect the change of coordinates using either bilinear or rotational transformation or by changing the mapping system from one type of coordinates to another. The principle involved here is that even if someone were able to somehow break into the system and begin decoding a sequence of data, the movement of the data would constantly break the decoding sequence attempted by an outside source. In other words, if the first data block was located and moved to an external location for decoding, the mapping or location of the second or subsequent data blocks would be changed before the external location could return with the now outdated location of subsequent data blocks since they have to be captured and decoded one at a time. The system could be further secured by placing random information in the first and last data blocks so that even if they were decoded, no real information would be compromised.

The patent and specification also allows for the modification of the data storage mediums by placing multiple access points in the data storage medium. For example, in the case of a hard disk drive, multiple read/write heads could be placed on a hard disk drive so as to allow multiple simultaneous reads and writes so as to not only improve seek and latency times during access to files but would allow the previously mentioned rapid message transfer system to work even more quickly.

### Program Flow

The program flow begins with the initialization sequence, which sets up the initial structure of the data storage medium as well as the initial data storage, which provides random background information for obscuring real data file and data block storage. The program will also provide a dummy structure of used data blocks for obscuring locations of initial data file storage, which may provide such a small number of data blocks as to be possibly copied if a search function happens to occur upon initial initialization. It should be noted that even if the initial data file were copied, this would not necessarily provide a method of copying subsequent data files as the system provides completely random storage for each data file and the pointers used in one system of a data file/data blocks are not the same as that used in subsequent data files/data block storage. It also would require a significant amount of time to decode a data file even if it were possible and by the time a data block was actually completely decoded, that data block and the remainder of the data blocks in that data file would have been moved and provided with new pointers and perhaps even a new file coordinate system.

Initialization Process

The initialization process complies with and follows the basic process in principle of this patent. Information storage or data files and data blocks as its implementation in the system follow the principle that information locations are set up in such a manner that it is impossible for an external source to access more than one data block at the same time. Mapping the password and data file system using nonsequential coordinates and nonsequential mapping of data files and data blocks makes it basically impossible to access a complete data file without using the write only programs stored in the microprocessor/microcontroller system. Therefore, external systems simply cannot proceed from one data block to another without decoding the addressing, which cannot be done in real time or before the addressing or mapping is changed (‘churned’) or the data file is moved to another location.

Coordinate Set Up

The initial coordinate set up may use any type of standard coordinate such as Cartesian or polar. In this system/flowchart description of a typical program operation, we will use Cartesian coordinates as the example system. While Cartesian coordinates could be set up in many ways on a hard disk drive or flash drive or other random-access system, the key feature of all of them is that they will be nonsequential. That is, one block or sequence of addresses in the coordinate system will not physically be adjacent to a succeeding block or sequence of addresses. In other words the first set of, say, 1000 binary data points will be written as part of the Cartesian coordinate system starting at 0, 0, 0 and extending to 0, 1000, 0 while the next thousand binary data points would start at, say, 3, 0, 10 and extend to 3, 1000, 10 with the same principle followed until 1000 positions are designated somewhere in each of the 3 axis system and a 1000 TB system can be accessed in Cartesian coordinates designated in nonsequential blocks instead of the normal sequential formatting.

Once the Cartesian coordinates are set up, other virtual coordinate systems can be written over it so that for instance a polar coordinate system could be set up that would be mapped to the Cartesian coordinates and through the Cartesian coordinates to the actual data points on the hard disk drive, flash memory system, or other memory system. The main mapping coordinate system can also be rewritten or mapped over at any point to change the 0, 0, 0 point either by rotating it in relation to the binary data points on the system or by using a covariant or contra variant linear transformation of the mapping system. Any of these changes would result in a change of the mapping system at any point in time, which would render it useless any previous attempts to penetrate the initial mapping system. This actually has the effect equivalent to rewriting the entire system of data blocks to different memory locations.

Once the initial memory system has been set up, the first linkage between a data file and the data file name and password stored on an external computer or preferably in a flash memory module physically removed from the computer system when it is not actually being used. While the password and its entanglement cannot currently be broken in a normal period of time, the future is unpredictable and it may be possible to come up with something that could break it so it is preferable simply to remove the password and entanglement from access by an external system.

Once the initial linkage between the password and the location in the memory system is established, great care must be taken to limit access to the password and its linkage. In addition to entangling the password in a large block of binary data points, the password linkage can be stored using the same methods used to store data files and data blocks. However, due to its close proximity (in the memory linking sense) to external access, the password linkage is slightly more vulnerable to external hacking simply because it is a small file or data block and thereby is more subject to random hacking and copying. Therefore, storing the linkages on a removable memory system that is physically stored with no contact to the computer system that controls the linkage can provide a much more secure location. The removable memory system can also include a read-only program that controls entering passwords and transferring them to the hard disk drive, flash memory, or other memory system so that the main controlling microcontroller/microprocessor system can access the correct file. The controlling program (whichever one is to be used) can then transfer the file or the entire area of the memory system containing the file to the removable memory system for transfer to another computer via physical transfer rather than computer transfer. If the transfer is done to a computer that has no linkage to the Internet or any other computer that might be connected to the Internet and in addition may even go to the extent of enclosing it in a Faraday cage so that an external entity or hacker cannot use a radio control bug to transfer information. While this may seem extreme, the importance of data security in a day and age when dozens of methods exist to intercept data requires the most extreme methods.

Once linkage has been established the actual data file and its data blocks can be stored using either a preset pattern or a random pattern that may or may not be enclosed within a smaller section of the memory system (for example a XYZ hard drive coordinate system could be broken up into 2 or 4 coordinate systems based on the Y and Z addresses (for example 2Y or 2Y/2Z) (breaking up the memory system into smaller sections is useful when it is desired to download a section for translation and decoding on a computer system not connected to the Internet (see above on password linkages) for maximum-security.

Preset patterns with variations are the easiest to use but it might be possible to guess a pattern once the initial addresses known and then grab the data without knowledge of the actual address locations and then break it off line. This is unlikely but must be considered as a possibility.

A preset pattern with variations might be considered as a two-dimensional or three-dimensional square wave or saw tooth pattern with offsets to break the continuity of the data. For instance a square wave may start at zero, 0, 0 and extend to 0, 0, 500 in a vertical sense and then the first horizontal pattern may start at 5, 5, 505 and extend to 505, 5, 505 and skip a different size block for extending downward. The square wave pattern could also be used, especially in polar or cylindrical coordinates to extend into three dimensions to further confuse the locations. Again, this may seem extreme but the entire purpose of this portion of the system is to provide a nonsequential, random sequence of locations even for something as simple as a square wave or saw tooth pattern. The entire purpose is to make it essentially impossible to decide where the data is by looking at the data itself. Once it is entangled and then nonsequential he stored, it is essentially impossible for an external system to provide a mathematical algorithm that can break the data without some knowledge of how the data is broken up and stored. It seems to be a truly unbreakable system.

Random data locations can be used to make the system even more difficult to break into. A random location scenario utilizes an encoded and entangled reference to both the previous and the succeeding memory block as well as information on the location of the succeeding memory block and its location parameters (1st point, direction, length, password information, entanglement information including sequence variations.). The information is part of the initial information on the decoding of the sequence by having the information of the succeeding memory block primarily stored in the preceding memory block. This allows the most variations (for example the memory could be stored in a three-dimensional U-shaped block) in the size and shape of a memory block. This may require that a particular data file be restricted to certain areas of the memory system to prevent overwriting from another data file. The number of methods of storing random or preset patterns essentially prevent any entity or hacker from establishing the location of data since the data by itself makes no sense unless it is correctly decoded which cannot be done without extensive knowledge of the patterns.

Data entanglement: basic data entanglement involves taking a 7 or 8 bit data representation which is equal to one character or symbol and then placing the binary data into a larger 16-BIT (obviously the larger size is a trade-off between the confusion factor in the amount of data to be stored—fortunately the cost of data storage has dropped to the point where it can be considered a nonfactor in secret data is to be placed on the computer) in a nonsequential manner. Each entanglement can be and should be unique so that each letter has a different pattern from the first or any previous entanglement pattern. What this means is that it would be impossible to do a frequency search for the letter E because each time the letter E is entangled, the binary data pattern is either unique (within this data file) or if it matches another binary data pattern, the letters or symbols encoded are unlikely to be the same.

Further confusion can be added by utilizing a 15 or 20-bit binary data pattern with a 7 or 9-bit character or symbol embedded in the larger pattern. What this means is that an entity or hacker does not even know how to break up the sequence into searchable code patterns.

As part of the initialization sequence of a hard disk drive or other random access memory system used in this system and process, the memory spaces can and should be filled with sequences of data and data files that resemble as close as possible the real data files and data blocks that will be stored securely on the system.

The only remaining thing that needs to be done after the initialization sequence is to provide a method of indicating which blocks and individual data points are being utilized by stored data files and data blocks. The method should not utilize the same grids and data location methods that are utilized in storing real data but should be provided by a different method of defining coordinates and may even utilize a mirror disk or mirror storage system to provide the data. Again this is an expensive method in terms of data storage but inexpensive in terms of the reliability of storing the data. A mirror disk need not be the same size as the data disk but could be emulated by a flash memory system that is much smaller than the hard drive data storage and simply provides a virtual map to data blocks or coordinate data blocks within the secure memory system. In other words, each block of, say, 1024 bytes of data could simply have a low-level pointer in a flash memory chip that would indicate that it was being used for data at this point in time.

Again, this is a very complex system but the entire system is based on complexity of the storage system instead of complexity of an encryption system because this actually makes sense simply because an encryption system is a well-known and relatively easily penetrated method of data security and often actually provides little or no security while the new paradigm will at least for the foreseeable future result in secure data storage.

The main program flow begins with the acquisition of a data file with an accompanying name. The data file may already be broken up into sections for storage or it may require sectioning by the microprocessor/microcontroller (hereafter microcontroller will refer to any hardware, method, or program controlling the storage and movement of the data). The data file name is associated with either a vector (polar, cylindrical or other type including tensors in some implementations) pointing to a starting location for the data, an XYZ location in Cartesian coordinates, or other mathematical method of indicating the first location for the string of data blocks. The pointer location name stored by the microcontroller will be entangled and use only the minimum number of characters to identify the data file. The pointer to the first location will be highly entangled (one real data bit to three or more dummy data bits). In some circumstances or implementations, the microcontroller will also allocate storage for a pointer to the last or intermediate data block location which will be filled after the date of the blocks are completely stored. This will allow read/write sequences to go from either end or other location within the data block sequence. This will allow later randomization of the data block sequence to further confuse efforts to correctly sequence the complete data file.

Once the first data block has been written to a given location, the microcontroller will select a second location based on either a predefined sequence of locations or a random or pseudorandom mathematical algorithm that will control the sequence of locations. A pseudorandom algorithm will be constrained to operate along existing sequences of data bits to minimize seek times and other constraints on speed of read/write operations. A fully random algorithm will operate along the virtual coordinate systems, which will result in very random hardware locations for each data bit. This would be highly difficult to evaluate and analyze but would be relatively slow in operation. This constraint could be alleviated by multiple access points within a flash/semiconductor memory or by using multiple read/write heads, perhaps as many as a dozen to allow look ahead seeks and copying in blocks. Given that the current design of hard disk drives and other memory systems with single entry points make it easy for hackers and other entities to monitor and access the information stored, perhaps it is time consider different hardware designs that would make it easier to secure the data stored in computer memory systems.

As part of the program flow data storage system, data and passwords can be encrypted either prior to or as part of the loading of data along with the entanglement algorithms used to secure the data and passwords. Regardless, once the system has received the data and placed it on the storage system, the microprocessor/controller will only be able to access the data files by going through the file name password first data block pathway, which would mean that it would make sense to have a secure backup in the microcontroller itself. In fact, in some systems it would be possible to have the most secure capability by using storage locations utilizing write only memory (EEPROM) that is only controlled through the microcontroller/microprocessor system.

Of course some variations of this system would require a new generation of hardware design but considering the relatively low cost of data storage in comparison to the high cost of hacking into or otherwise compromising storage of confidential/top-secret information, it is perhaps, as previously mentioned, time to look at a new paradigm which uses large amounts of data storage locations to prevent compromise of data security. Since a 2 TB hard drive has a retail price of approximately $100, a 16 platter hard Drive with 16 TB even with 12 heads per platter could conceivably retail for $1000 or less and be well worth the expense for cloud server or other storage system. A cost of 10 to 50 GB for a penny means that using 100 GB to spatially encode and entangle 20 GB of information is well worth it.

The string of data blocks that compromise the entire data file would contain a pointer to the previous data block and a pointer to the succeeding data block. All data blocks would be entangled with the pointers either being part of the same entanglement or utilizing a separate entanglement system in order to further confuse location and analysis of the sequence. The separate entanglement of the pointers would be useful during transformation and changes of the coordinate system as it would allow changes to the pointers only without the extra time involved in changing the data block entanglement.

In the case of entangled letters and numbers in the text, security cannot only be the result of basic entanglement but can also use algorithms such as sequential entanglement (where each sequential letter starts the same basic pattern at a later location in the dummy bits; i.e. 3, 5, 9 followed by 4, 6, 10,) or inverted entanglement were sequential letters are flipped so the last data bit one encoded in all even letters). Other patterns can also be used effectively especially since only the microcontroller will know and understand what particular data patterns are being used in the entanglement process.

Once the data file has been fully stored, it may be assigned a priority within the data file system as to how often it will be rewritten to a new location. Whether or not a priority system exists as part of the data storage system is a choice for the operator/programmer of the system and may either be hardwired or selectable as part of the microcontroller program.

In a multiple platter implementation of the system, data files on one platter may be sequentially written to another platter within the system. This would allow, for example, a 16 platter system to have one blank platter for use as a buffer storage location for the data from another platter (platter a) while data from platter B is written to platter a whereupon data from platter C is written to platter B and so on in a continual sequence of movable data. The sequence could also be done with single files or groups of files being moved from one platter to another for continuous changing of locations to make it impossible to analyze, decode, and track the location of any particular data file.

### Password Protection

The issue of having an outside entity necessarily have access to the beginning of each file requires the use of entanglement of passwords and filenames with large ratios of dummy data to active data and can be alleviated by having a small number of large files stored rather than many small files. In the extreme, all of your data that needs to be secured could actually be stored in one large file where it could be accessed without the use of filenames and instead will hold a password encoded as binary data that is not necessarily related to each individual letter of the password but may be a selected subset of the passwords binary equivalent which is then entangled with a large number of dummy data bits. Such a system should be almost impossible to break because there is no relationship between the location of the password data bits (and filenames data bits if used) and the external password.

Cloud-based systems using multiple disks and multiple heads or data systems with multiple entry points could use a separate system to store passwords and filenames while the separate system could store its passwords and filenames on the first mentioned system. In other words, cloud-based systems could help each other with security by storing or actually being the entry point for a separate distinct memory system so that the pathway for accessing a file would go through one memory system to the second one where it will be in this memory system where the data is actually stored. Since a hacker or other entity trying to find a file or otherwise access the system will have no idea where the data is actually stored until after they are able to crack the password and find the location of the next data block (and it is unlikely that they could do that before the data files and entry points/passwords are churned and shuffled), they will not be able to access the data. It is also possible to place random data (except for required linkage information) or deliberately confusing patterns (including linkage information) within the first few data blocks for obvious purpose and results. The combination of non-mathematical quasi random block storage sequences and multiple heads or entry points with complex mathematical algorithms that can be changed randomly at the behest of the hardware and software systems.

Non-cloud-based systems can utilize the same general principle. Existing single or multiple hard drive or other memory system types can use a subset of the system, which will be limited to movement within the main system hard disk drive, an external hard drive (if available) and flash drive USB plug-ins or equivalents. This type of system would be more dependent on the security of data entanglement since the area to use for encoding is limited.

1) I claim that this patent covers all forms of nonsequential storage of data blocks (linked using entangled pointers stored in random location—usually within the data blocks) as well as completely entangled data or similarly encoded storage of data as well as nonsequential mapping of coordinate systems (as specified in the system description) to data blocks on all forms of random-access storage devices including, but not limited to, hard drives, flash memories, rewritable CD's and DVD's as well as any form of random-access rewritable semiconductor memory (including storage devices that utilize multiple hardware and software access points in order to speed up read/write cycles as well as place entangled data locations/bits utilizing complex formats—storing a single location of the sixteen bit entangled symbol on each one of a sixteen platter hard drive) that is available for storing data in either a pattern of blocks that matches the text order, or a pattern of blocks that may be spatially stored in a quasi-random pattern and may be partially (for example the linkages between blocks) or completely encoded using data entanglement so as to completely confuse and obfuscate an entities attempts to access the data and break the coding.

2) I claim that this patent covers all forms of real-time active manipulation of data that it is constantly either the linkage between data blocks being readdressed or physically moving data blocks from one location to another in a random-access memory system of any type using mathematical transformations, location change algorithms that change the base position of the coordinate system by remapping the addresses or address variables or remapping basis (mathematical definition) systems and the use of entangled variables within each data block location that specify location pointers for adjacent data blocks which can be manipulated by the microprocessor/microcontroller system and therefore provide for easy movement or churning of data either within a specified memory system or another linked memory system which is available for storage of data files during the churning operations or for storage of allocation tables and any other required data including the (encoded) storage of algorithm or algorithms used (including dummy usage) in the encoding, entanglement, and addressing of data blocks and linkages for a particular data file.

3) I claim that this patent covers all forms of data entanglement which is defined (in this patent) as a unique nonrepeatable pattern of binary bits representing the first (original) occurrence of a character or symbol within a data file (subsequent occurrences of a character or symbol will be encoded differently and stored in different locations in a different sequence-) of a character or symbol is “entangled” or randomly stored within a larger pattern of binary bits so as to hide the real character or symbol from anyone who is not familiar with the software controlling the storage medium as well as the algorithm or algorithms defining and directing the encoding, and also has access to the microcontroller creating the entangled patterns while the entangled pattern may be any number of data bits stored in any sequence, sequential pattern, or nonsequential pattern within a larger number of random or quasi random data bits so as to prevent correct decoding of the data and by using preset patterns, predefined algorithmic patterns, and random algorithmic patterns generated by the microprocessor/microcontroller or computer system will thereby create a system of such complexity, confusion, and diffusion that it will maintain total security as defined by Shannon's paper and definitions.
